(19) United States
(12) Patent Application Publication
(10) Pub. No.: US 2010/0145505 A1
(43) Pub. Date: Jun. 10, 2010

(54) Method for Handling of Banknotes and Similar Articles

(76) Inventor: Kjell Lindskog, Skelleftea (SE)

Correspondence Address: Mark P Stone, 25Third Street, 4th Floor, Stamford, CT, 06905, US

(21) Appl. No.: 11/992,557

(22) PCT Filed: Sep. 27, 2006
(86) PCT No.: PCT/SE2006/001096

§ 371 Date: Mar. 25, 2008

(30) Foreign Application Priority Data
Sep. 28, 2005 (SE) 0502118-3

(51) Int. Cl. G06F 7/00

(52) U.S. Cl. 700/228

(57) ABSTRACT

A data processing apparatus operate to process floating point operands is disclosed. The data processing apparatus comprises: an instruction decoder operable to decode an instruction for processing floating point operands; and a data processor operable to perform data processing operations controlled by the instruction decoder wherein: in response to the decoded instruction indicating operation according to a flush-to-zero semantic, the data processor is operable to process the floating point operands in accordance with the decoded instruction such that floating point operands having a denormal value are treated as zero operands; and in response to the decoded instruction indicating operation according to a denormal semantic, the data processor is operable to process the floating point operands in accordance with the decoded instruction such that floating point operands having a denormal value are treated as denormal operands.

The present invention relates to the field of data processing of floating point numbers and in particular to the field of data processing of floating point numbers including denormal or subnormal number representations.

Many architectures provide support for operating on floating point numbers including denormal or subnormal number representations, such as floating point number representation defined by the IEEE754 specification. This representation of floating point numbers has become the accepted standard and is supported in some form by architectures including Alpha, ARM, Intel X86, IA64, MIPS, PA-RISC, Power PC, SH, SPARC.

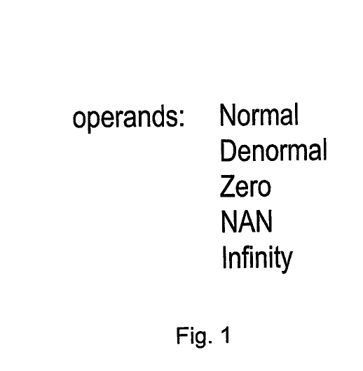

The IEEE754 specification defines five different classes of floating point numbers. FIG. 1 shows these five different classes. They include a signed Zero, Normal numbers, represented as a signed bit, a normalised fraction and an exponent, and Denormal numbers which are numbers that are too small to be represented by the normal number format and these have a similar format to the Normal numbers and are identified by an exponent of zero.

The IEEE754 specification sets out the semantics of operations performed on these bit fields. These semantics are adopted widely, but a second set of semantics have also emerged which treat denormal numbers differently to that defined in the IEEE754 specification. These semantics treat denormal number representations as if they were zero, and are usually provided with the aim of reducing implementation complexity. In this regard there are two common semantics for dealing with floating point numbers that can represent denormal numbers; Denormal semantics wherein denormals are treated as denormals, and Flush-to-zero semantics wherein denormals are treated as zeros. Providing support for denormal numbers can be expensive, both in hardware cost or execution time if denormal semantics are emulated in software. Furthermore, these numbers do not occur very frequently and in many situations (such as for example in many graphics calculations) an approximation of a denormal number to zero provides sufficient accuracy. However, in some circumstances, such as for example, Java processing, approximating to zero is not acceptable and thus, denormals must be supported. Therefore these two semantics are both valuable for processing floating point numbers.

Most architectures have therefore been developed to support both semantics and do so by providing for two different modes of operation. In one mode, denormals are simply treated as zeros, this is generally called flush-to-zero mode and in the other denormal mode they are treated as denormals. The actual mode to be used in a particular instance is indicated by a mode bit held in a configuration register.

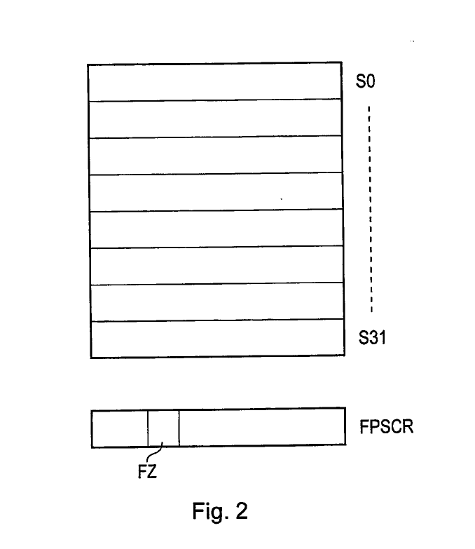

One example of this is found in an ARM (registered trade mark of ARM Limited Cambridge UK). FIG. 2 shows the floating point operand, storage registers S0-S31 and the FPSCR, floating point status and control register of this product. The FPSCR stores a number of mode bits including the flush to zero control bit, FZ, which is bit 24 in the FPSCR. This bit can be configured by particular dedicated instructions within the floating point instruction set.

Implementing the hardware in this way has been found to be advantageous. This is because flush-to-zero approximations are sufficiently accurate in many situations, while in situations where the accuracy of such an approximation is not sufficient, a desired result can still be obtained by operating within the denormal mode. For these reasons implementations using two modes with a FTZ mode bit stored in a configuration register to indicate which mode to operate in has been used in all major architectures to deal with denormals in floating points. Examples of systems that use this include, Alpha, ARM, Intel X86, IA64, MIPS, PA-RISC, Power PC, SH, SPARC.

Although a mode bit provides processors with the choice of semantics they need, problems can arise in certain situations.

Program optimisation tools that analyse program code, such as Dynamic Translators, have difficulty analysing program code containing floating point instructions because their operation depends on additional state elements that define a mode of operation. The analysis is difficult as the analyser does not know how the code will operate as this depends on state elements whose values it does not know. Thus, for some instructions and operands there are two possible operations to consider and the analyser does not know which will be performed. Static analysis by itself cannot determine the semantics of a particular instruction. In addition, the same instruction may have different semantics at a different point in time throughout the execution of a program, complicating the analysis further. Thus JITs or dynamic optimisation of code whose operation depends on additional state elements is not straightforward.

A further problem associated with programs containing floating point instructions whose operation depends on additional state elements may arise where switching between modes is desirable within a program. For example, a main routine may operate fine in flush-to-zero mode, while a subroutine requires a mode that supports denormals. In such a case, to avoid switching modes, the whole application could operate in denormal mode, which would be very slow. Furthermore, it may produce errors as the main routine will only have been validated in flush-to-zero mode and may not operate correctly in denormal mode. The whole application could operate in flush-to-zero mode but this could again produce errors. Alternatively, switching between modes can be implemented by way of specific instructions to overwrite the FTZ bit in the configuration register. However, this is complicated because, as the subroutine is unaware of the mode of operation of the main routine, to ensure safe operation it must not only write to the FTZ bit to ensure it has the correct value for its preferred mode of operation, but it must also store the current value of the FTZ so that it can restore it when it has finished. This ensures that the routine that called it continues to operate in the correct mode. If there are many nested routines, this can be quite a complicated and costly procedure.

Additionally when testing a routine containing floating point instructions whose mode of operation depends on configuration bits set in a configuration register, a routine may be validated in one mode, while it may fail when operating in the other not tested for mode.

A first aspect of the present invention provides a data processing apparatus operable to process floating point operands said data processing apparatus comprising: an instruction decoder operable to decode an instruction for processing floating point operands; and a data processor operable to perform data processing operations controlled by said instruction decoder wherein: in response to said decoded instruction indicating operation according to a flush-to-zero semantic, said data processor is operable to process said floating point operands in accordance with said decoded instruction such that floating point operands having a denormal value are treated as zero operands; and in response to said decoded instruction indicating operation according to a denormal semantic, said data processor is operable to process said floating point operands in accordance with said decoded instruction such that floating point operands having a denormal value are treated as denormal operands.

The present invention recognises the problems associated with mode bits within a configuration register indicating the semantics of operation within floating point instruction processing. It provides an elegant solution to this problem, by providing the information regarding whether the semantics supports flush-to-zero or supports denormals within the instruction itself. This means that the semantics of operation is statically defined within the code, rather than dynamically defined in a register. This has advantages in several contexts. For example, the code can be statically compiled. A test bench testing code will test the code in the appropriate mode and thereby provide a reliable result. An analysis and optimisation of the code can be effectively performed by dynamic optimisation programs.

It should be noted that although elegant, this solution is counterintuitive to engineers in the field, as there is a general desire in data processing to reduce the size of instructions. Thus, there is a deep-seated prejudice against including additional information within an instruction. For this reason many of the problems discussed above have not been identified let alone addressed and all major architectures that implement these two floating point semantics provide mode bits within configuration registers to indicate flush-to-zero or denormal supported modes of operation.

Although said instruction can indicate the semantics of operation in a variety of ways, in preferred embodiments said instruction comprises a semantic indicator bit operable to indicate operation according to either said flush-to-zero semantic or said denormal semantic.

Including a semantic indicator bit within the instruction is a simple way of indicating the semantics that is easy to decode.

Although the instruction can comprise a variety of operations, in some embodiments it comprises one of an add, multiply or a compare instruction.

Operations performed on denormals are often adds, multiplies or compares and as such these instructions benefit from indicating the semantics within the instruction.

In some embodiments, said data processing apparatus is operable to process floating point operands, said floating point operands being represented in an IEEE754 format.

Although floating point operands can be representative in a variety of ways, they are widely represented by the IEEE754 format. The present embodiment are particularly appropriate at processing these floating point operands.

Additionally, said data processing apparatus is operable to process floating point operands, said floating point operands being represented in a half precision format comprising a sign bit, five exponent bits and ten fraction bits.

Half precision format although not part of the IEEE7544 specification is an effective way of representing floating point operands in some circumstances. Instructions of the present embodiment support this format.

A further aspect of the present invention provides a method of processing floating point operands comprising: receiving an instruction for processing floating point operands at an instruction decoder; and processing said floating point operands in response to said decoded instructions, wherein in response to said decoded instruction indicating operation according to a flush-to-zero semantic, said floating point operands having a denormal value are treated as zero operands and in response to said decoded instruction indicating operation according to a denormal semantic, said floating point operands having a denormal value are treated as denormal operands.

A yet further aspect of the present invention comprises a computer program product comprising at least one instruction operable to process floating point operands, said computer program product being operable when run on a data processor to control the data processor to perform steps of the method according to a further aspect of the present invention.

Embodiments of the present invention will now be described, by way of example only, with reference to the accompanying drawings, in which:

FIG. 1 shows different floating point operands supported by IEEE754 format;

FIG. 2 schematically shows registers for floating point operands and a floating point status control register according to the prior art;

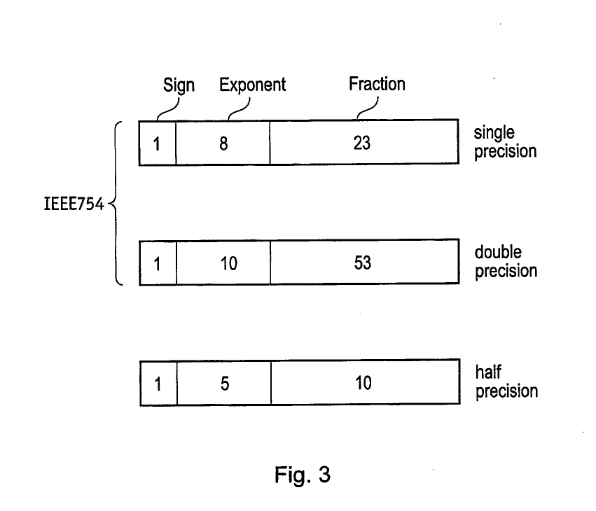

FIG. 3 shows different formats for floating point operands;

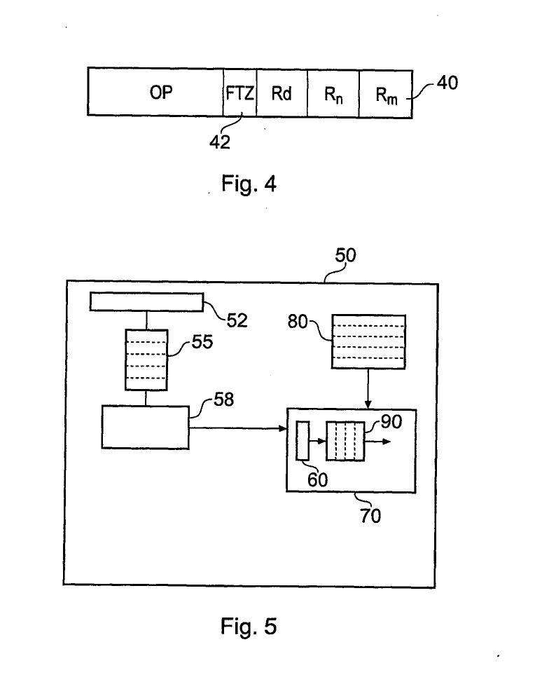

FIG. 4 shows an instruction according to an embodiment of the present invention;

FIG. 5 shows a data processing apparatus according to an embodiment of the present invention; and

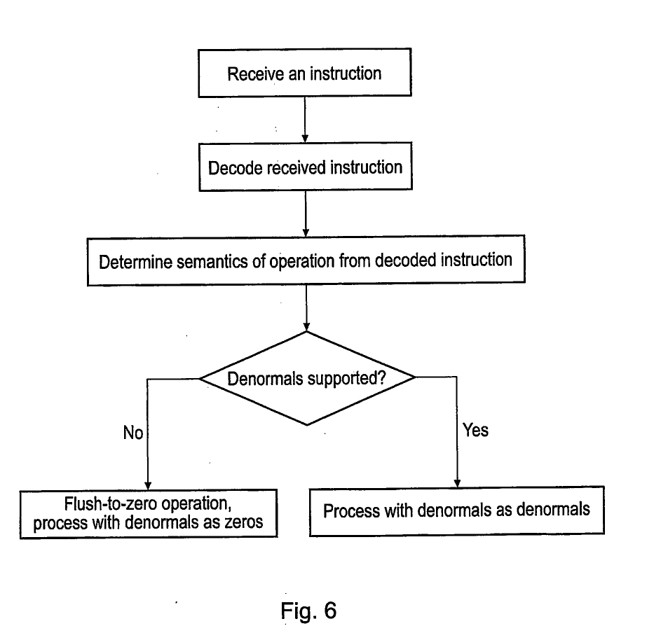

FIG. 6 shows a flow diagram of a method according to an embodiment of the present invention.

FIG. 3 shows the form at of floating point numbers written using the IEEE754 standard in single precision and double precision. They have a sign bit indicating if the number is positive or negative, an exponent portion, and a fraction portion. A half precision number is also shown, which although not part of the IEEE754 standard, can be processed by embodiments of the present invention.

FIG. 4 shows an instruction 40 according to an embodiment of the present invention. Instruction 40 comprises an operation code OP, an FTZ or semantic indicator bit 42, and register fields indicating where source and destination values are stored. Semantic indicator bit 42 indicates to the data processing apparatus 50 whether the instruction should be processed in flush-to-zero semantic where denormals are processed as zeros or in denormal semantic where denormals are supported. Although in this embodiment the information regarding the semantics of operation is included as a semantic indicator bit 42 within the instruction in other embodiments this information is included in a different form but is nevertheless derivable from the decoded instruction.

FIG. 5 shows a data processing apparatus 50 according to an embodiment of the present invention. Data processing apparatus 50 comprises and instruction store, 52, 55, an instruction prefetch unit 58, a data processor 70, and a floating point operand store 80. The data processor comprises an instruction decoder 60, and execution pipeline 90.

Data processing apparatus 50 processes instructions such as instruction 40 illustrated in FIG. 4. These instructions 40 are retrieved by instruction prefetch unit 58 from either an instruction cache 55 or a memory 52. The retrieved instructions are then passed to data processor 70, where they are decoded by instruction decode 60. The decoded instructions then control data processor 70 to process floating point operands stored in data store 80, which may be a memory, a cache or a register bank. The data processor processes the floating point operands in accordance with the decoded instructions and the semantics indicated by the semantic indicator bit 42 of the instructions. Thus, if the decoded instruction indicate a flush to zero semantic, the processor treats all denormals processed by that instruction as zeros and their processing is supported by hardware. If the decoded instruction indicates a denormal semantic then all denormals are treated as denormals and in this embodiment, at least a part of their processing is performed by emulating the floating point operation in software. Denormal processing is complicated and as denormals occur reasonably rarely, in this embodiment the hardware does not support them, and they are therefore emulated by software, the software routine being stored in memory. This has an advantage in the simplification of the hardware, but a disadvantage in the speed of processing of the denormals. It should be noted that in other embodiments the denormal calculations may be supported by hardware rather than by a separate software subroutine.

FIG. 6 shows a method of processing floating point data according to an embodiment of the present invention. In a first step an instruction is received and then it is decoded. The instruction comprises an indicator of the semantics of operation of the processor while processing that instruction and the semantics of operation is thus determined from the instruction. In this embodiment bit 42 being enabled indicates processing to be performed in flush-to-zero semantic where denormals are treated as zeros and execution occurs within the pipeline, while bit 42 not being enabled indicates that denormals are supported and in this case detection of a denormal value will trigger a jump to a subroutine that supports the denormal calculations.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A data processing apparatus operable to process floating point operands
said data processing apparatus comprising:
an instruction decoder operable to decode an instruction for processing floating point operands; and
a data processor operable to perform data processing operations controlled by said instruction decoder wherein:
in response to said decoded instruction indicating operation according to a flush-to-zero semantic, said data processor is operable to process said floating point operands in accordance with said decoded instruction such that floating point operands having a denormal value are treated as zero operands; and
in response to said decoded instruction indicating operation according to a denormal semantic, said data processor is operable to process said floating point operands in accordance with said decoded instruction such that floating point operands having a denormal value are treated as denormal operands.

2. A data processing apparatus according to claim 1, wherein said instruction comprises a semantic indicator bit operable to indicate operation according to either said flush-to-zero semantic or said denormal semantic.

3. A data processing apparatus according to claim 1, wherein said instruction comprises one of an add, a multiply or a compare instruction.

4. A data processing apparatus according to any preceding claim, wherein said data processing apparatus is operable to process floating point operands, said floating point operands being represented in an IEEE754 format.

5. A data processing apparatus according to any preceding claim, wherein said data processing apparatus is operable to process floating point operands, said floating point operands being represented in a half precision format comprising a sign bit, five exponent bits and ten fraction bits.

6. A method of processing floating point operands comprising:
receiving an instruction for processing floating point operands at an instruction decoder; and
processing said floating point operands in response to said decoded instructions, wherein in response to said decoded instruction indicating operation according to a flush-to-zero semantic, said floating point operands having a denormal value are treated as zero operands and in response to said decoded instruction indicating operation according to a denormal semantic, said floating point operands having a denormal value are treated as denormal operands.

7. A method according to claim 6, wherein said instruction includes a semantic indicator bit operable to indicate operation according to either said flush-to-zero semantic or said denormal semantic.

8. A method of processing data according to claim 6 or 7, wherein said instruction comprises one of an add, a multiply or a compare instruction.

9. A method of processing data according to any one of claims 6 to 8, wherein said data processing method is operable to process floating point operands in the IEEE754 format.

10. A method of processing data according to any one of claims 6 to 8, wherein said data processing apparatus is operable to process floating point operands in a half precision format comprising a sign bit, five exponent bits and ten fraction bits.

11. A computer program product comprising at least one instruction operable to process floating point operands, said computer program product being operable when run on a data processor to control the data processor to perform the steps of the method according to any one of claims 6 to 10.
